(19) United States
(12) Patent Application Publication
(10) Pub. No.: US 2004/0058639 A1
(43) Pub. Date: Mar. 25, 2004

(54) Air flow controller and fire damper in an air flow duct

(76) Inventor: Richard Perrin, Kent (GB)

Correspondence Address: Dickstein Shapiro, Morin & Oshinsky, 2101 L Street NW, Washington, DC, 20037-1526, US

(21) Appl. No.: 10/433,309

(22) PCT Filed: Nov. 29, 2001
(86) PCT No.: PCT/GB01/05279

(30) Foreign Application Priority Data
Dec. 1, 2000 (GB) 0029281.1
Apr. 24, 2001 (GB) 0110056.9

(51) Int. Cl. A62C 2/12; A62C 2/18

(52) U.S. Cl. 454/369

(57) ABSTRACT

A fire damper in an air duct (2) is formed by a flap (12) which in its closed position bears on a flange (6) which extends inward from the duct wall, to form a seal. The flap (12) is biased to the closed position and held open by a cable (24) which is gripped by a releasable mechanism, such as a ball clutch. The release is triggered by a fusible cartridge (34) which extends into the duct (2).

The present invention relates to a fire damper for use in an air flow duct, and to a damper which can be used to regulate the flow of air in the duct.

Fire dampers in air flow ducts are well known. A commonly used form of damper consists of a flap inside the duct, which is held in an open position, extending along the duct axis. A heavy spring biases the flap to a closed position where it is transverse to the duct axis to block off the duct. A temperature sensitive trigger holds the flap in the open position and releases the flap in the event of a temperature rise caused by fire, such as a flame front moving through the duct.

The prior art system suffers from a number of drawbacks. The seal between the duct wall and the flap relies only on the flap edge abutting the duct wall, and so smoke can move past the flap, although soot and other debris eventually help to form a seal. Distortion of the duct wall is a common occurrence and this impairs the seal.

Building regulations typically require installation of a fire damper in the wall of the room or compartment through which the duct passes. This makes access to the flap, to reset it, difficult. However, regulations also require that the flap be triggered many times on installation to ensure that it is functioning properly. Typically, the flap is mounted on an axle extending across the duct, and a handle on the axle extends outside the duct to enable an operator to return the flap to the open duct position.

Another draw back with the prior art system is that the flap is either fully opened or fully closed. It is often desirable to balance or control the flow through a duct, but the prior art design cannot use the flap for this additional purpose.

A first aspect of the present invention provides a fire damper in a ventilation duct, the damper comprising a flap which is pivotably mounted in the duct for movement from an open position, allowing air flow along the duct, to a closed position under the action of a biasing force to inhibit air flow or the passage of flame along the duct, wherein a rim is provided on the duct wall and the flap overlaps and bears on the rim when in the closed position.

Preferably the flap is pivoted about a centre axis. The rim may be stepped to accommodate opposite sides of the flap, but preferably the rim is in a single plane and the flap is stepped to mate with the flange.

As well as providing a better seal, the construction of the flap closing down onto a rim is more robust and better able to withstand continuous testing without distortion of the flap or surrounding duct. The rim, when mounted on the wall of the duct, serves to reinforce the duct shape. The rim may have a flange which extends laterally across the duct, the flap bearing on the flange when the flap is closed. Preferably the rim forms a corner and a co-operating corner is provided on the flap to form a seal at the corner.

Another aspect of the invention provides a damper in a ventilation duct, the damper comprising a flap which extends within the duct, wherein the flap is biased towards a first position, tending to open or close the duct, and a cable extends from the flap to the exterior of the duct, and means is provided for gripping the cable to hold the flap against the biasing force, whereby the orientation of the flap in the duct can be adjusted via the cable.

Preferably the flap is biased to a position closing the duct and a temperature actuated release is provided to trigger the release of the cable by the gripping means.

Very preferably the cable is gripped by a ball clutch. The cable may be pulled through the ball clutch, in the direction of flap opening, manually or by other means such as an electric motor or pneumatic device. It will be appreciated that the cable could also be turned around a pulley wheel which is rotated by a stepper motor or the like and released automatically to release the flap under control of a temperature sensor, override switch, etc.

Other aspects and preferred features of the invention will be apparent from the following description and the accompanying claims.

The invention will now be described by way of example with reference to the accompanying drawings, in which:

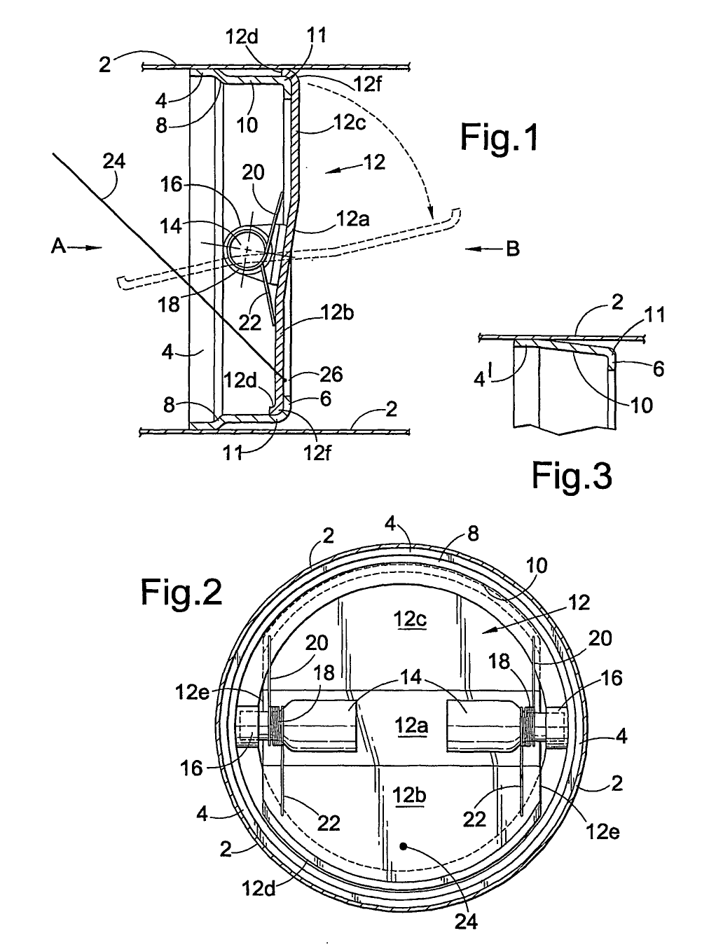

FIG. 1 shows schematically in cross-section a first embodiment of the invention, which is particularly suitable for small size ducts, typically up to 25 cm or 35 cm across but can also be used with larger size ducts;

FIG. 2 is a view on arrow A of FIG. 1;

FIG. 3 shows a modification of the embodiment of FIG. 1;

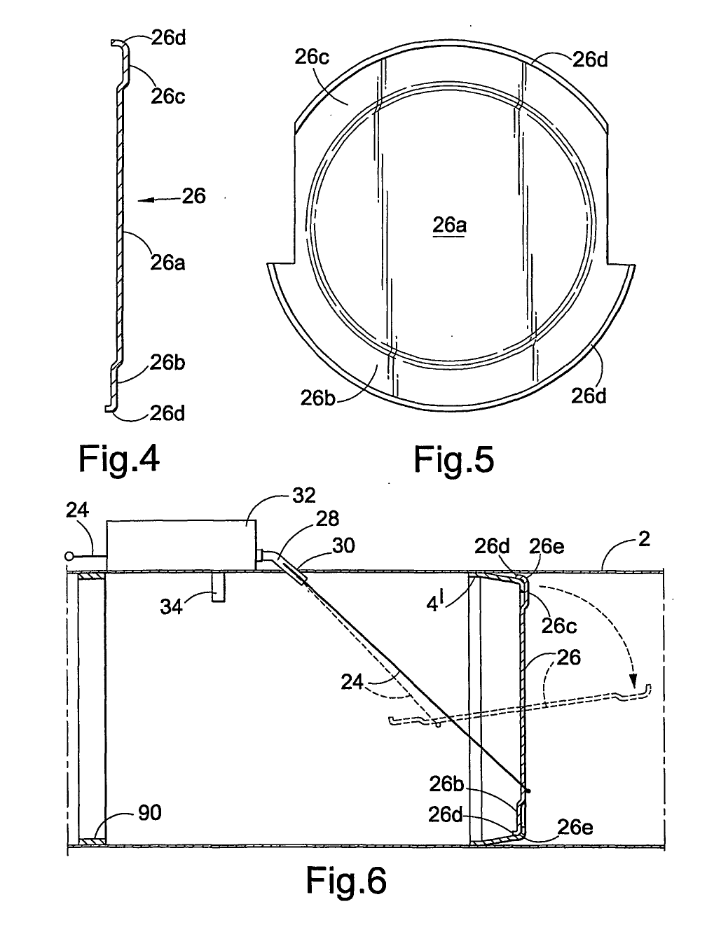

FIG. 4 shows in cross-section a second embodiment of a flap of the invention, which is particularly suitable for larger size ducts;

FIG. 5 is a plan view of the flap of FIG. 4;

FIG. 6 is a cross-section view illustrating a control mechanism of the invention;

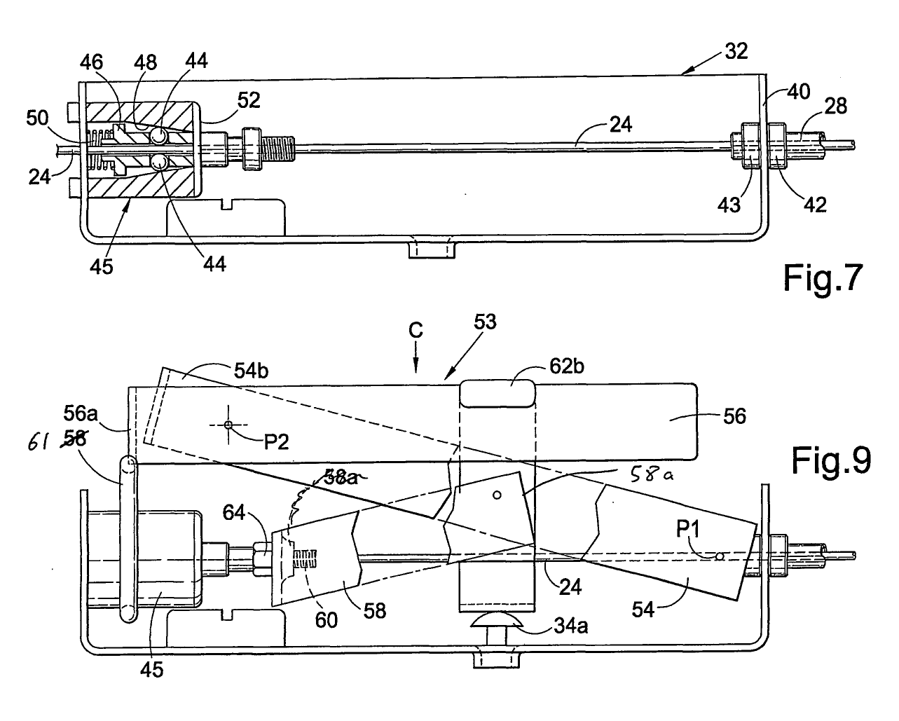

FIG. 7 is a detail of the control mechanism of FIG. 6 with some parts omitted;

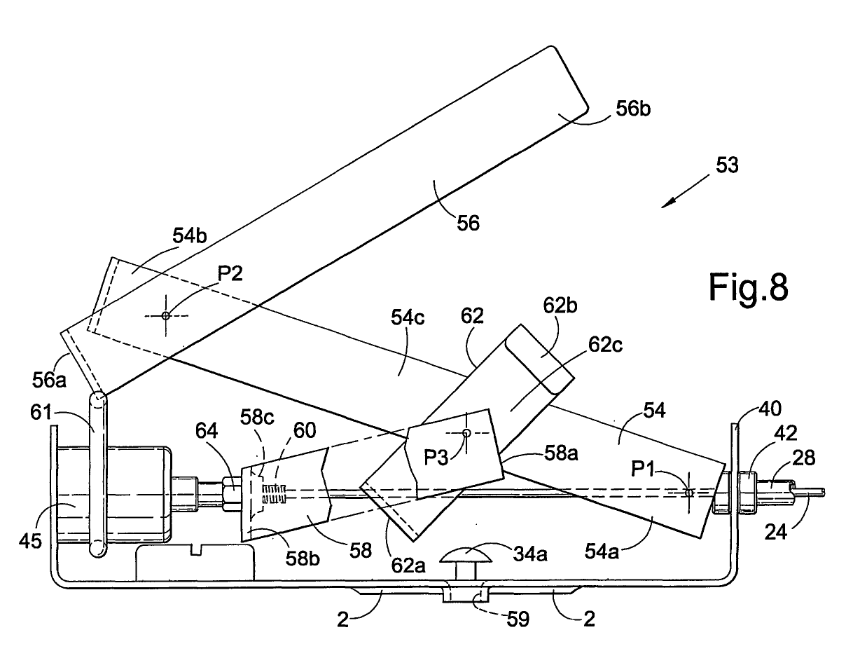

FIG. 8 is a side view of the control mechanism of FIG. 6, when it is being set;

FIG. 9 is a side view of the control mechanism of FIG. 6, when it is set;

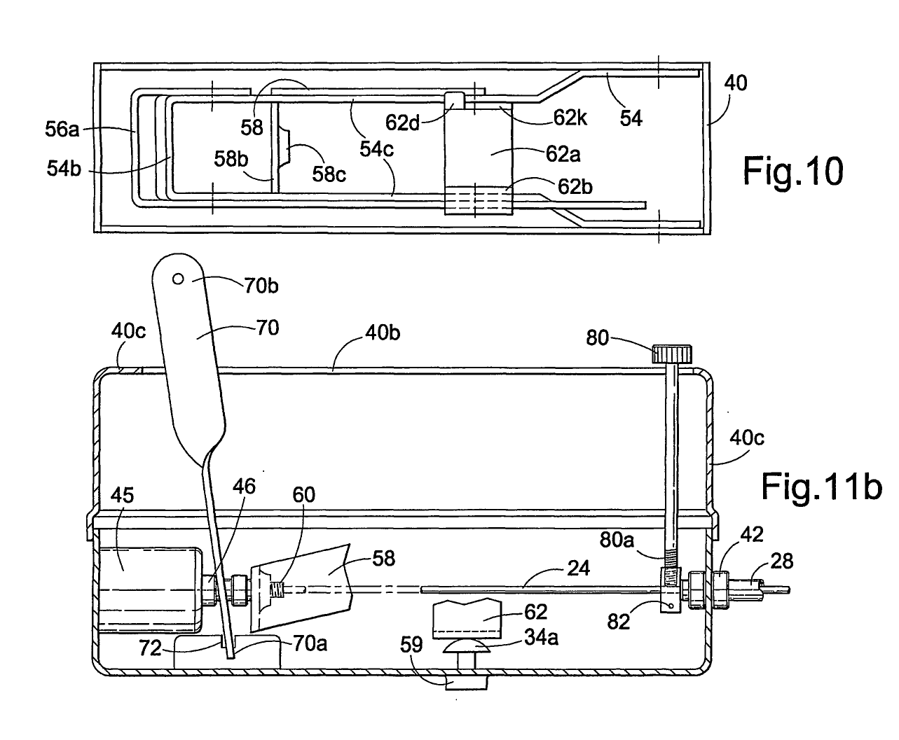

FIG. 10 is a view on Arrow C of FIG. 9;

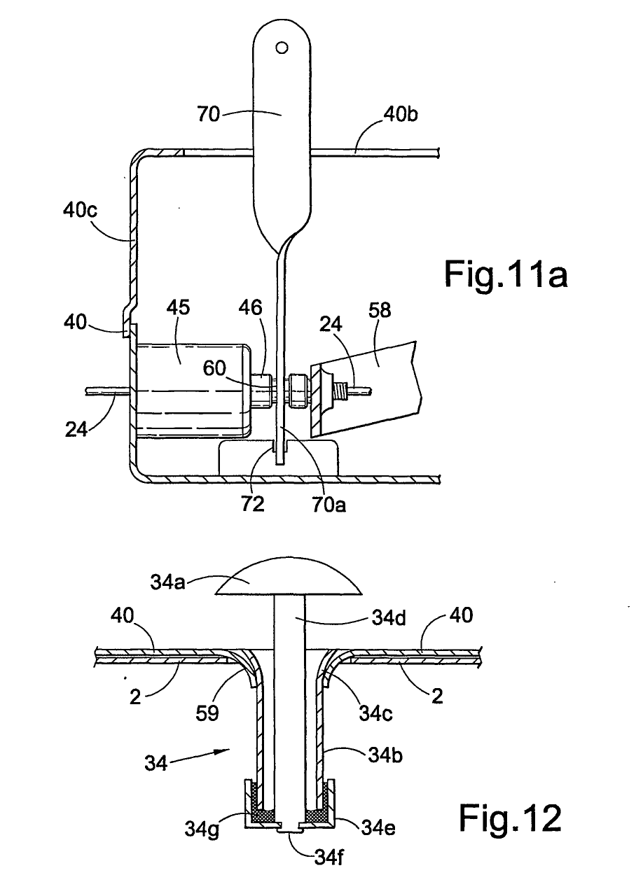

FIGS. 11a and 11b show the operation of a manual override lever in the mechanism of FIG. 6, and FIG. 11b also shows a visual indicator of the flap position;

FIG. 12 is a cross-sectional view of a temperature actuated release of the mechanism of FIG. 6;

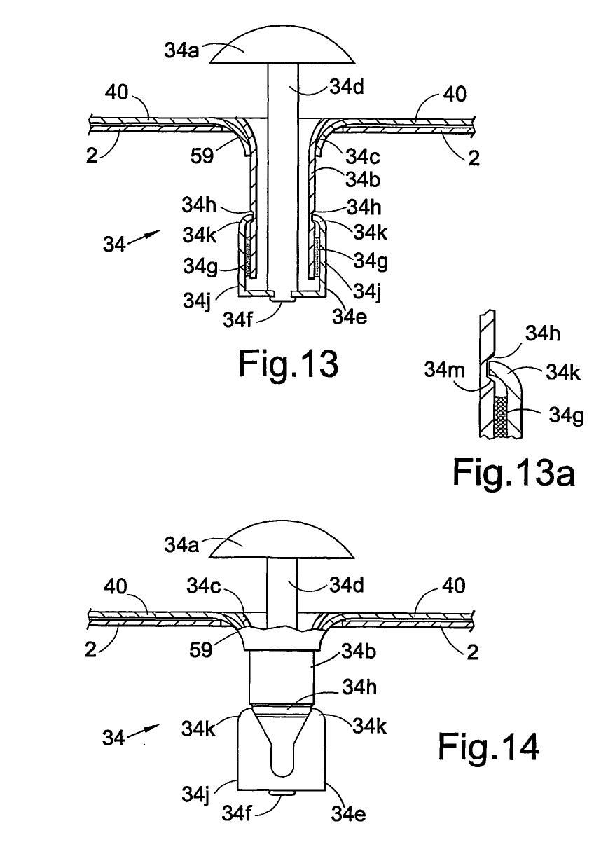

FIG. 13 is a cross-sectional view of a modification of the temperature actuated release mechanism of FIG. 12, FIG. 13a showing a detail, and

FIG. 14 is a side view of the mechanism of FIG. 13.

FIGS. 1 and 2 show duct wall 2 which is circular in cross-section. A continuous circular rim 4 having an inwardly extending flange 6 is riveted to the duct wall 2 at several positions around the rim by sealed rivets (not shown). The rim 4 has a step 8, to form a wall portion 10 which is spaced from the duct wall 2. The rim serves to provide a mounting and a stable mating surface for a flap or blade 12, and also strengthens the duct to maintain the duct shape in the region of the flap 12 to provide improved operation.

The flap or blade 12 is pivotably mounted on the rim 4 and is shown in full outline in its closed position, and in dotted outline in the open position.

As seen in FIG. 1, the blade is stepped or joggled at a diameter region 12a so that the halves of the flap 12b, 12c occupy planes to either side of and parallel to the plane of the flange 6, when the flap is in the closed position.

Referring to FIG. 2 the flap 12 is mounted on two stub axles 14 which rotate in sockets 16 formed on the rim 4. The stub axles 14 are a good fit in the sockets 16 to reduce any tendency of the flap to wobble, and also to provide a degree of sealing against the passage of smoke when the flap is closed. A single axle extending across the diameter of the flap may be used. The ends of the axle(s) may be sealed.

Heavy duty, i.e. strong, coil springs 18 surround the axles 14, and have one leg 20 bearing on the flange 6, and the other leg 22 bearing on the flap 12 to bias the flap into the closed position, against the flange 6.

The flap 12 is cut away at the edge 12e of the diameter region 12a, near the stub axles 14, to just clear the flange 6.

A cable 24 is attached at one end 26 to the flap region 12b and extends diagonally of the duct to exit through the duct wall 2, as will be described more fully hereinafter with reference to FIG. 6 et seq.

The flap 12 is overturned at its outer perimeter to form an axially extending flange 12d and a corner 12f to embrace the rim at the corner 11 formed at the radially outer edge of the flange 6 in portion 12c, and sit snugly at the corner 11 formed between the flange 6 and wall 10 at flap portion 12b. The flange 12d serves to strengthen the flap 12 to retain the shape of the flap during repeated operation and also provides an improved seal, as will be described hereinafter.

In operation, the cable 24 is pulled to rotate the flap 12 into the open position, shown in dotted outline, against the force of the springs 18. In the event of a fire, the cable 24 is released, allowing the flap to rotate to the closed position under the force of the springs 18. The overlap of the perimeters of the flap portions 12b, 12c adjacent flange 12d with the flange 6, and particularly the overlap at the corners 11, 12f ensures a good seal. The regions 12e, where the flap 12 is cut away may allow a small mount of air or smoke to pass but this will be rapidly blocked by soot etc., in the event of a fire.

By means of the cable 24, the flap 12 can be held in an intermediate position, thus serving to control the flow of air through the duct during normal operation. Typically, the degree of opening of the flap 12 would be set on installation of the system to balance air flow through the system, and then left.

In FIG. 3, the cross-section of the rim 4′ is modified to replace the step 8 by an angled wall 10′.

In the duct 2 the normal air flow is in the flow direction of arrow A. Thus the fixings, such as the rivets holding rim 4 in place and the exit for cable 24, are closed or sealed. This reduces the risk of smoke escaping through the fixings once the flap 12 is closed. It will be appreciated the arrangement could be reversed, with air flowing in the direction of arrow B.

FIGS. 4 and 5 shows a flap 26 which is a modified form of the flap 12. The centre portion 26a of the flap is flat. The outer perimeter of the flap is stepped to mate with the flange 6 of FIG. 1 At portion 26c the edge of the flap is dished, ending in a circumferential rim 26d forming a corner 26e and the flap 26 is stepped at portion 26b, with circumferential rim 26d forming a corner 26e.

The control of the flap 12, 26 by means of the cable 24 will now be described in more detail with reference to FIGS. 6 to 12.

FIG. 6 shows a flap 26 closing a duct 2 by bearing on a rim 4′. The stub axle mounting and spring biasing of the flap 26 are not shown but are as described with reference to FIGS. 1 to 5. The cable 24 exits the duct 2 at an angled tube 28 which extends through an aperture 30. A grommet (not shown) is provided on an end of the tube 28 to form a seal with the cable 24. Tube 28 is mounted on a control mechanism 32 which is riveted to the duct 2. Also shown in FIG. 6 is a fusible cartridge 34 which provides the temperature sensor of the temperature actuated control for releasing the cable 24 to allow the flap 26 to close.

Referring to FIG. 7, this shows a cross-section through the control mechanism 32. Mechanism 32 is contained in a housing 40 which is riveted to the duct 2 by sealed rivets (not shown). Cable 24 passes through tube 28 which is fixed to the housing 40 by nuts 42, 43. The cable 24 passes through the housing 40 and a ball clutch 45 mounted at the end of the housing 40 opposite inlet tube 28.

Ball clutches are well known and described for example in Ingenious Mechanisms by Franklin D. Jones, Vol. 2, Industrial Press Inc., Page 428. In brief, the cable 24 passes through a piston 46 and is gripped by two or more balls 44 which are held in the piston 46. Piston 46 is contained in a block 52 and is urged towards a conical surface 48 by a spring 50. Conical surface 48 forces the balls 44 inwards, to grip the cable 24. If the cable 24 is pulled to the left as seen in the drawing, which will open the flap 12, 26, this causes the piston 46 to move leftwards against the force of the spring, releasing the balls 44, so that the cable can then be pulled freely through the clutch.

Piston 46 extends outwards of block 52. Thus, the clutch can be released by urging piston 46 leftwards from outside the block 52. This forms the basis of a release mechanism for releasing cable 24, triggered by cartridge 34, to allow the flap 12, 26 to close.

FIGS. 8 and 9 are side view shows showing a release mechanism 53. FIG. 8 shows the mechanism 53 being set, and FIG. 9 shows the mechanism 53 after it has been set.

Referring to FIG. 8, a first lever 54 is pivotally mounted at a pivot point P1 at one end 54a in the housing 40. A second lever 56 is pivotably attached to the other end 54b of the first lever 54 at a pivot point P2, and attached to a coil spring 61. Coil spring 61 passes around the block 52 of ball clutch 45 and is attached at each end to the lever end 56a.

A release member 58 is pivotally attached at one end 58a to a central region 54c of lever 54 at a pivot point P3. Release member 58 is U-shaped and a web 58b has an aperture 58c which passed over a stub axle 60 formed on the end of the piston 46 where it projects from the block 52.

It can be seen that as the free end 56b of lever 56 is urged downwards, it will urge lever end 54b downwards, in turn moving lever portion 54c down and to the left as it pivots about pivot P1, thus urging the release member 58 leftwards. Release member 58 pivots at pivot P3.

A U-shaped break member 62 is also pivotably mounted on lever 54 at pivot point P3. Member 62 has a web 62a which, when the mechanism is “loaded”, bears on the head 34a of cartridge 34. Break member 62 limits the downward movement of lever 54 (FIG. 9), and so limits the leftward travel of the release member web 58b.

Referring to FIG. 9, the lever 56 has been pushed fully downwards, and is clipped under a finger 62b formed at the end of arm 62c of brake member 62.

It can be seen that lever end 54a is fixed by pivot point P1, and lever 54 is held against further downward movement by brake member 62 bearing on head 34a of cartridge 34. The mechanism is tensioned by spring 61 which pulls lever end 56a downwards. In this “set” position, web 58b of the release member 58 rests just short of an adjustable nut 64 on stub axle 60.

As will be described with reference to FIG. 12, when release cartridge 34 is heated, as by flames in duct 2, head 34a drops, allowing brake member 62 and lever 54 to pivot further downwards, urging release member web 58b leftwards to bear on nut 64, and hence urge the piston 46 leftwards to release the ball clutch 45. Cable 24 is thus released, and flap 12, 26 is forced closed by the springs 18. Head 34a of cartridge 34 will seal the aperture 59 formed in housing 40 and the duct wall 2.

Referring to FIG. 10, a lug 62d on the other arm 62k of break member 62 prevents the member pivoting past the head 34a when the mechanism is being set.

To test that the flap 12, 26 closes, a manual release mechanism is provided, as shown in FIGS. 11a and 11b. A manually operated lever 70 pivots at one end 70a in a notch 72 and has a slot. (not shown) which embraces the stub axle 60. As the lever is pivoted to the left about notch 72, as shown in FIG. 11b, the piston member 46 is urged leftwards to release the ball clutch 45. Lever 70 slides in a slot 40b in the housing cover 40c.

Also shown in FIG. 11b is an indicator for allowing visual inspection of the flap portion. The indicator is an elongate pin 80 which is screwed at one end 80a into a nipple 82 fixed in position on the cable 24, and extending through slot 40b. As shown in FIG. 11b, the cable has been released and the flap 12, 26 is in the closed position. As the cable is pulled leftwards, opening the flap, the pin 80 is slid along the slot 40b.

To allow for release of the flap 12, 26 by other devices, e.g. smoke alarms or fire alarms external of the duct, an electromechanical actuator may be mounted on lever 70 at the outer end 70b.

The release cartridge 34 is carried by the base of the housing 40 and projects into the duct 2. FIG. 12 shows a cut-away detail view of release cartridge 34. A pin casing 34b is of brass and swaged over at its outer end 34c and a push fit in the extruded aperture 59 in the housing 40. Steel pin 34d has a brass cup 34e mounted on its lower end by a rivet 34f. Cup 34e is attached to casing 34b by solder 34g, holding the pin 34d raised in the casing 34b. When heated, as by flames, solder 34g melts, so that the break member 62, which urged against the pin head 34a by spring 61, will force the pin 34d downwards through the casing 34b, at the same time triggering the release of the cable via release member 58. Cup 34e remains on the end of the pin 34d, and so there is no risk of it fouling the flap 12, 26.

The release cartridge is intended to trigger or fuse close to a pre-determined temperature governed by the melting point of the solder 34g, say at about 70° C. However, the solder may soften appreciably below this temperature.

From FIG. 12 it can be seen that the solder 34g is in shear between the casing 34b and the wall of cup 34e. Hence it is possible for the cartridge to trigger below the designated temperature because the sustained pressure on pin 34d from the release mechanism, via break member 62, will slowly cause the solder to shear, allowing pin 34d.to drop into the cylinder 34b.

To overcome this, the embodiment of FIGS. 13 and 14 uses a mechanical or form-locking connection between the cup 34e and the casing 34b which resists the shearing force between cup 34e and casing 34b.

A circumferential slot 34h is provided in the outer surface of the casing 34b. Cup 34e has two diametrically opposed legs 34j which extend upwards and end in inturned nibs or lips 34k which engage in slot 34h. Solder 34g holds the legs 34j against the outer surface of casing 34b. Slot 34h has a sloping lower wall 34m on which the lip 34k bears.

The pressure on pin head 34a, from break member 62, will tend to force the lips 34k out of engagement with slot 34h. This requires outward flexing of the legs 34j which is resisted by the solder 34e bonding the legs 34j to the cylinder 34b. Solder 34e is not under substantial shear, and the force tending to separate the legs 34j is lower than the shearing force of the FIG. 12 embodiment because the force is acting in a different direction. Thus solder 34g will not creep or give significantly until it is at or near its designed melting point, of about 70° C. in this example.

When the solder 34g reaches its melting point, the legs 34j are released, and the force on head 34a of pin 34d is sufficient to drive the cup 34e down, disengaging the lips 34k from sloping wall 34m of slot 34h. In turn, the trigger mechanism releases the flap 26, as described above.

The flap 26, rim 4 and release mechanism 32 may be provided as an assembly or kit to be fitted in a length of duct. Preferably a length of duct is pre-fitted with the assembly, ready for installation in a building etc. To further strengthen the duct against deformation, a rim or band 90 may be fixed upstream of the flap 26.

Although the invention has been particularly described with reference to a circular cross-section duct it may also be used with a square or rectangular cross-section duct.

Various modifications will be apparent to those in the art. Although the invention has been described with particular reference to circular cross-section ducts, it can be used with rectangular or other cross-section ducts.

1. A fire damper in a ventilation duct, the damper comprising a flap which is pivotably mounted in the duct for movement from an open position, allowing air flow along the duct, to a closed position under the action of a biasing force to inhibit air flow or the passage of flame along the duct, wherein a rim is provided on the duct wall and the flap bears on the rim when in the closed position to form a seal.

2. A fire damper as claimed in claim 1, wherein the flap is mounted to pivot about a central axis.

3. A fire damper as claimed in claim 2, wherein a radially extending flange is provided on the rim.

4. A fire damper as claimed in claim 3, wherein the flap is stepped in the region of its centre axis, the flap portion either side of the step laying flat against respective sides of the flange when the flap is in the closed position.

5. A fire damper as claimed in any one of claims 1 to 4, wherein the flap is mounted on an axle which turns in a socket on the inside of the duct wall.

6. A fire damper as claimed in any one of claims 1 to 5, wherein a corner is formed where the flange extends inwardly of the rim, and the flap has a corner formed at its peripheral edge to mate with the corner on the rim.

7. A fire damper as claimed in any one of claims 1 to 6, wherein the rim extends substantially continuously around the inner surface of the duct wall.

8. A fire damper as claimed in any one of claims 1 to 7, wherein the flap is held in the open position by a cable which extends from the flap to outside of the duct.

9. A fire damper as claimed in claim 8, wherein the cable is held outside the duct by a release mechanism, which releases the cable if a fire is detected in the duct.

10. A fire damper as claimed in claim 8 or 9, wherein means is provided for holding the cable at different positions to hold the flap at positions intermediate the open position and the closed position.

11. A fire damper in a ventilation duct, the damper comprising a flap which is biased to a closed position to close off the duct, wherein means is provided to hold the flap at one of a number of open positions and means is provided to release the flap automatically in response to a pre-determined event.

12. A fire damper as claimed in claim 11, wherein the degree of opening of the flap is continuously variable from the closed position.

13. A flap in a ventilation duct for controlling air flow through the duct, wherein means is provided to bias the flap towards a first orientation in the duct and means is provided to move the flap to a second orientation in the duct, and in which holding means is provided to hold the flap at any position between the first and second orientations.

14. A flap as claimed in claim 13, wherein the holding means is a cable which extends from the flap to outside the duct, and means is provided outside the duct for holding the cable.

15. A flap as claimed in claim 14, wherein the means for holding the cable comprises a ball clutch.

16. A flap as claimed in claim 14 or 15, wherein the means for holding the cable includes a trigger for releasing the cable.

17. A flap as claimed in any one of claims 13 to 16, wherein in the first orientation the flap closes the duct.

18. A trigger for releasing a flap in a ventilation duct, to close the flap, the flap being held in an open position by a releasable mechanism, the trigger comprising a lever which is biased to a first position in which the lever releases the releasable mechanism, and temperature responsive means holding the lever away from the first position, the temperature responsive means releasing the lever in response to a rise in temperature.

19. A trigger as claimed in claim 18, wherein the lever comprises a first member which is pivotally mounted at one end, and a second member pivotally mounted at the other end of the first member and attached at one end to a spring to provide the biasing force and arranged to be releasably fixed at the other end relative to the first member.

20. A trigger as claimed in claim 19, wherein a third member is pivotally mounted at one end on the first member and guided at its other end to contact the releasable mechanism when the lever is released by the temperature responsive means.

21. A trigger as claimed in claim 19 or 20, wherein a fourth member is provided and attached to the first member, the fourth member bearing on the temperature responsive means to limit movement of the first lever by the spring.

22. A trigger as claimed in any one of claims 18 to 21, wherein the temperature responsive means is a pin which is held captive in a housing by a fusible material.

23. A fuse comprising a pin held captive in a tube by a heat softenable material.

24. A fuse as claimed in claim 23, wherein the pin has a cup at one end, the cup being attached to the tube by the heat softenable material.

25. A fuse as claimed in claim 24, wherein the cup is riveted to the end of the pin.

26. A fuse as claimed in claim 24, wherein a form locking connection is provided between the cup and the tube, the form locking connection being released when the heat softenable material softens.

27. A fuse as claimed in claim 25, wherein the form locking connection holds the pin against movement through the tube in an axial direction, and is formed between the tube wall and a leg on the cup, the leg tending to move outwardly to release the connection when a force is applied to the pin, and the heat softenable material bonds the leg to the tube.
